(19) United States
(12) Patent Application Publication
(10) Pub. No.: US 2019/0174721 A1
(43) Pub. Date: Jun. 13, 2019

(54) ANIMAL CONTROL SYSTEM AND METHOD PROVIDING INFORMATION ACCESS AND CONTROL

(71) Applicant: DogWatch, Inc., Natick, MA (US)

(72) Inventors: Norval Stapelfeld, Manchester, NH (US); Frederic T. Peterson, Chelmsford, MA (US); Daniel V. LaRue, Newbury, MA (US); Martin E. Bures, Somerville, MA (US); Eric W. Brown, Saugus, MA (US); Nicholas B. Mertaugh, Lawrence, MA (US); Robert M. Kaufman, Acton, MA (US)

(21) Appl. No.: 15/840,719

(22) Filed: Dec. 13, 2017

(51) Int. Cl. A01K 27/00; A01K 29/00; A01K 15/02

(52) U.S. Cl. CPC A01K 27/009; A01K 15/029; A01K 27/001; A01K 29/005

(57) ABSTRACT

A system and method for monitoring and reporting to a system user, operational information pertaining to a base station and one or more collar modules of an animal control and activity level and behavior information pertaining to one or more monitored pets. Information regarding the base station and the one or more collar modules is communicated to the system user via a communications portal and a web application executing on a web server. System users interface with the web application via a computer network, e.g. the Internet, and may access information from a location remote from the animal control system through the web application. System users may also modify the operation of the base station, collar modules and/or communications portal by issuing commands to such devices through the web application. The web application also issues alerts and/or notifications to one or more system users.

### STATEMENT REGARDING FEDERALLY SPONSORED RESEARCH OR DEVELOPMENT

Not Applicable

### BACKGROUND OF THE INVENTION

The present invention relates to an animal control system and more particularly to a system and method for providing access to information pertaining to the operation of components of the animal control system, information pertaining to the activity level and behavior of a pet and additionally, permits a user to control aspects of the operation of components of the animal control system from a remote location.

Animal control systems that include a base station that includes transmitter circuitry that energizes a boundary wire and collar circuitry affixed to a collar worn by a pet are well known in the art. The boundary wire in such systems defines a pet confinement area or alternatively, an area from which the pet is to be excluded. The collar circuitry includes a receiver that detects an RF boundary wire signal radiated from the boundary wire. When the pet approaches the boundary wire, the signal is verified. When the strength of the signal reaches a threshold value, the collar circuitry generates an audible stimulus signal or, alternatively, subjects the pet to an electrical correction signal or stimulus (electric shock) to deter the pet from advancing further toward the boundary. In response to the audible signal or electrical stimulus, the pet is trained to refrain from approaching the boundary wire.

Users of such animal control systems, for various reasons, are at times not in a position to monitor the operation of the system. For example, a pet owner may be away from home and unaware of changes in the operational state of the system.

Most animal control systems that are commercially available are stand-alone systems that include no facility for communicating information regarding the system or the pet to remote users or the ability to remotely modify operational parameters of the system. U.S. Pat. No. 8,006,649 which is assigned to the present assignee recognizes that a correction monitor signal indicative of a correction and the time of the correction may be transmitted to one or more remote locations and that the information may be posted to a website which can be accessed to display the number of corrections that have occurred during a defined period of time. This patent also recognizes that various other conditions relating to conditions at a home may be communicated to a remote location and displayed, e.g. water in the basement, electrical failure, and other such conditions. U.S. published application 2016/0021850 which is assigned to the present assignee recognizes that GPS information identifying the location of an animal may be sent to a central server and that the owner of the animal may access the central server via a web page over the Internet to obtain the animal's location. U.S. Published application 2016/0021850 which is assigned to the present assignee teaches that upon recognition that an animal is inside or outside of an area defined by the boundary wire, additional operations may be implemented, including initiating a radio or text message from collar circuitry. Additionally, location information, e.g. from a GPS locator may be transmitted in order to allow for locating and retrieving the animal. A General Radio Packet Service (GRPS) operates to transmit SMS text messages or the like via a mobile data service and a transmitter/receiver may also communicate with a home base station on another channel different from the GRPS channel.

An animal control system may become non-functional for various reasons. A power outage may result in an inability of the base station to transmit the boundary wire signal and, even if a battery backup system is available, the backup system will only provide power for a limited period of time. Since collar circuitry is affixed to a collar worn by the pet, the collar circuitry is battery powered. If the battery ceases to provide sufficient power to the collar circuitry, the collar circuitry will be unable to detect the boundary wire signal or generate a stimulus and the animal control system will cease to function. The system will also become non-functional in the event of a break in the boundary wire.

For the above reasons as well as other reasons, it would be desirable for a pet owner or another user of such a system, such as dealers, service providers, and others, to be able to access information regarding the operational parameters and status of such a system, even when remotely located from the control area defined by the boundary wire. Additionally, it would be desirable for the pet owner or user of the system to be able to have access to information pertaining to the activity level and behavior of the pet and, if desired, to be able to control the operation of the system from a location remote from the control area should circumstances warrant changes in operation. In this manner, a system user would be able to identify and/or address conditions that might adversely affect the operation of the animal control system and/or the safety or status of the pet.

### BRIEF SUMMARY OF THE INVENTION

In accordance with the present invention an animal control system is disclosed that provides the ability to monitor operational characteristics, parameters, and status of components of the system and/or activity levels of a pet from locations which may be remote from a pet confinement or exclusion area (“control area”). The system allows a system user to obtain access to the operational characteristics, parameters and/or status of components of the system as well as information pertaining to the activity levels and/or behaviors of a pet from a location remote from the control area. Additionally, the disclosed system provides alerts and/or notifications to a pet owner or system user through a computer network, such as the Internet. Furthermore, the system provides the system user with the ability to modify operational parameters of the system to control various aspects of system operation via a computerized device, such as a desktop or laptop computer, a tablet, a mobile device, such as a smartphone, or any other suitable computerized device.

The disclosed animal control system includes a base station that includes a transmitter that transmits a boundary wire signal over a boundary wire at a first carrier frequency. The boundary wire defines the controlled area of the animal control system. The animal control system further includes collar module affixed to a collar worn by the pet. The collar module includes a receiver that is configured to receive a radio frequency signal having the first carrier frequency that is radiated from the boundary wire. The first carrier frequency is modulated, such as by using frequency shift keying (“FSK”) modulation, to convey commands from the base station transmitter to the receiver within the collar module to set certain operational parameters of the receiver. As is known in the art, the boundary wire signal is detected by the receiver and generates an audible or electrical stimulus to the pet in response to certain conditions.

The base station and the collar module in the disclosed system each include an RF transceiver that utilize a second carrier frequency that is different from the first carrier frequency. The RF transceivers in the base station and collar module each communicate wirelessly with a cooperative RF transceiver in a communications portal and convey operational information pertaining to the respective device to the communications portal via the portal RF transceiver. Additionally, the collar module may convey information pertaining to the activity level and/or behaviors of a pet to the communications portal. The collar module may monitor and store such information irrespective of its location with respect to the animal control system, however, the information is only forwarded to the communications portal when in RF communication range of the communications portal.

The communications portal forwards the information received from the base station and the collar module to a web server via a computer network, which may comprise a world-wide computer network, e.g. the Internet. To this end, the communications portal includes a network interface for communication via a communication link or links over the computer network to the web server. The communications link may comprise a wired link, a wireless link, or a combination of wired and wireless link portions.

The web server may comprise one or more servers, such as servers in the “cloud,” that is/are operative to execute a web application. Such servers include processors and memory operative to execute one or more computer programs to perform the functions herein described.

A device protocol server (DPS) may be disposed between the communications portal and the web server. The DPS may perform information collection, packet formatting, message decoding and database functions. Alternatively, the functions performed by the DPS may be integrated within the web server. The web application receives and manages access to the information communicated to the web server from the communications portal. Additionally, the web application forwards to the base station and/or collar module commands in response to user instructions as subsequently described in greater detail.

System users may interface to the web application via a computerized device that is communicably coupled to the web server via a computer network interface to the computer network, e.g. the Internet. The communications link between the computerized device and the web server may be wired, wireless or comprised of a combination of wired and wireless links. The system users may access the operational parameters, characteristics, status, and pet activity levels and/or behaviors monitored by the base station and the collar module through the web application.

Additionally, a system user may issue commands from the computerized device to modify the operation of the base station or the operation of a collar module. Such commands are conveyed through the web application and via the communications portal to the base station or collar module to which the command is addressed.

The base station, one or more collar modules and the communications portal are each provided with a unique identifier (ID). The information conveyed by the base station and each collar module to the web server via the communications portal is associated with the unique ID assigned to the respective component of the animal control system.

A plurality of collar modules affixed to collars worn by a corresponding plurality of pets may be employed in the presently disclosed animal control system to accommodate use of the system with multiple pets. The collar module associated with each collar is assigned a unique ID. Accordingly, information associated with each pet and the associated collar module may be separately monitored and accessed by the system user via the computerized device. Additionally, commands may be forwarded to the communication portal, the base station and to each collar module by addressing the commands to the respective components using their unique IDs.

The unique IDs may not only be unique within the specific system, but additionally, may be distinct from all other base stations, and collar modules and communications portals deployed in other animal control systems within a geographic area or worldwide. By the use of such unique IDs, it can be assured that information obtained by a system user via the communications portal and the web application pertains specifically to a particular component or pet and not to other components or pets associated with other animal control systems which may be in the vicinity.

The present animal control system utilizes an initiate-response communication protocol to confirm to a transmitting device that inter-component communications have been received. Additionally, the system may transmit using transceivers in the base station, collar module(s) and the communications portal that operate using a single carrier frequency for the communications therebetween. Alternatively, the communications portal, base station and/or collar module(s) may provide frequency agility, active channel (frequency) selection and antenna space or polarity diversity to avoid interference and improve RF communications between system components.

Additional features and aspects of the presently disclosed system and method will be apparent to those of ordinary skill in the art in view of the following Detailed Description of the Invention in conjunction with the drawings.

### DESCRIPTION OF THE SEVERAL VIEWS OF THE DRAWINGS

Non-limiting embodiments of the present invention are described by way of example with reference to the accompanying figures. The same reference numbers appearing in the various figures are intended to refer to the same component or element. For purposes of clarity, every component or element may not be labeled in every figure, nor is every component of each embodiment shown where illustration is not necessary. The invention will be more fully understood by reference to the Detailed Description of the Invention in conjunction with the Drawings of which:

FIG. 1 is a block diagram of an animal control system operative in accordance with the present invention;

FIG. 2 is a block diagram of the base station of FIG. 1;

FIG. 3 is a flow diagram illustrating the operation of the base station of FIG. 2;

FIG. 4 is a block diagram of the collar module of FIG. 1;

FIG. 5 is a flow diagram illustrating the operation of the collar module of FIG. 4;

FIG. 6 is a block diagram depicting the communications portal of FIG. 1;

FIG. 7 is a flow diagram illustrating the operation of the communications portal of FIG. 6;

FIG. 8 is a schematic diagram of a base station coupled to a boundary wire defining a pet containment area, a pair of collar circuits associated with respective pets located within the containment area, and a communications portal for communicating with the base station and collar modules that each include unique identifiers for identifying the respective components and information associated with the respective components;

FIG. 9 is a flow diagram of a method for performing active channel selection and transmit antenna diversity; and

FIGS. 10a-10e illustrate methods of operation within a device protocol server and a web application in accordance with the present invention.

### DETAILED DESCRIPTION OF THE INVENTION

In the following description, numerous specific details are set forth in order to provide a thorough understanding of the embodiments of the present invention. It will be understood by those of ordinary skill in the art that these embodiments of the present invention may be practiced without some of these specific details. In other instances, well-known methods, procedures, components and structures may not have been described in detail so as not to obscure the embodiments and methods employed in accordance with the present invention.

Prior to explaining at least one embodiment of the present invention in detail, it is to be understood that the invention is not limited in its application to the details of construction and the arrangement of the components set forth in the following description or as illustrated in the drawings. The invention is capable of other embodiments or of being practiced or carried out in various ways. Also, it is to be understood that the phraseology and terminology employed herein are for the purpose of description and should not be regarded as limiting.

It is appreciated that certain features of the invention, which are, for clarity, described in the context of separate embodiments, may also be provided in combination in a single embodiment with other embodiments disclosed herein. Conversely, various features of the invention, which are, for brevity, described in the context of a single embodiment, may also be provided separately or in any suitable sub-combination.

It will be helpful to understand known systems in order to further understand embodiments of the present invention described herein. U.S. Pat. Nos. 5,353,744, 6,360,698, 6,575,120, 6,825,768, 8,006,649 and US published application 2016/0021850 of the assignee of the present invention describe the operation of animal control systems as known in the art and are incorporated herein by reference.

In accordance with the present invention, a system and method for providing users of an animal control system with the ability to obtain access to information regarding operational parameters, characteristics and status information (“operational information”) pertaining to components of the animal control system as well as information pertaining to the activity level and behaviors of a pet confined by or excluded from an area defined by a boundary wire (the “control area”) is disclosed. The operational information, activity level and behavior information is communicated to a system user via a communications portal and a web server. System users may include pet owners, service providers, dealers, customers or others permitted access to such information and/or persons or entities provided with authorization to modify the operational parameters within the animal control system. Users may access the web server via a computerized device that may communicate with the web server over a computer network. The disclosed system and method provide the ability for a system user to modify certain operational information from computerized devices which may be remote from the control area. In addition, the disclosed system may provide notifications and/or alerts to a system user in response to the detection of specified conditions or events. The disclosed system forwards such notifications and/or alerts to one or more specified system users, and additionally allows customization of the notifications and/or alerts provided to recipients.

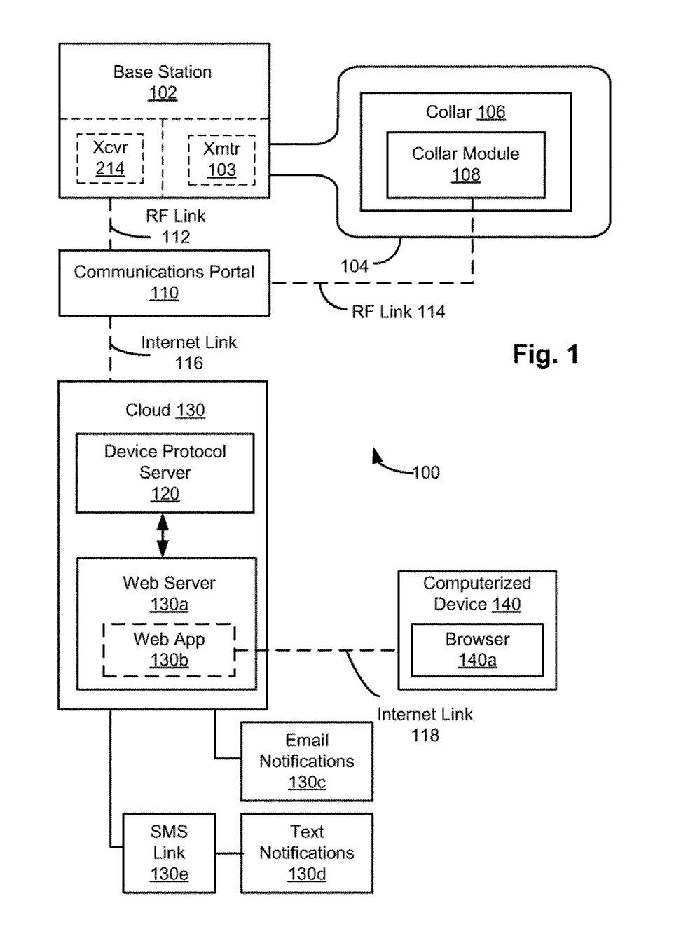

Referring to FIG. 1, the animal control system 100 includes a base station 102 that transmits an RF boundary wire signal through a boundary wire 104. The base station 102 includes a first transmitter 103 that transmits the RF boundary wire signal at a frequency between 1 and 20 khz. In one embodiment the transmitter 103 may transmit using a first carrier frequency of either 4 khz or 8 khz, the first carrier frequency being user. Additionally, the animal control system 100 includes one or more collar modules 108 affixed to corresponding collars 106 worn by one or more pets. The term collar module is used herein to refer to electronic circuitry and/or hardware, computer software and/or combinations of the foregoing that are configured and operative to provide the functions described herein. The animal control system 100 also includes a communications portal 110 that communicates with the base station 102 and the one or more collar modules 108 via RF links 112, 114 using a second carrier frequency that differs from the first carrier frequency. The second carrier frequency may be selected to be between 10 khz and 6 gigahertz. In one embodiment, the second carrier frequency is between 800 megahertz and 1 gigahertz. More specifically, in one embodiment, the second carrier frequency is at or about 900 Mhz. In another embodiment that employs Bluetooth™, the second carrier frequency is at approximately 2.4 gigahertz and in yet another embodiment employing WiFi communications, the second carrier frequency is at or about 2.4, 3.6, 4.9, 5 or 5.9 gigahertz. Moreover, any suitable wireless protocol that provides wireless communications between the communications portal 110 and the base station 102 and between the communications portal 110 and the collar module(s) 108 may be employed.

The communications portal 110 interfaces to one or more web servers 130a in the cloud 130 via a communications link 116 of a computer network, e.g., a world-wide communications network, such as the Internet. In the illustrated embodiment, the communications link 116 is an Internet link. The one or more web servers 130a execute a web application 130b as subsequently discussed.

In one embodiment, as illustrated in FIG. 1, a device protocol server (“DPS”) 120 is disposed between the communications portal 110 and the web server 130a. The DPS 120 receives and decodes messages from the communications portal 110 that are destined for the web server 130a and formats the messages for communication to the web application 130b. The DPS and the web server 130a may comprise one or more physical servers or virtual machines in the cloud. The functions of the DPS 120 may be provided in a server distinct from the web server 130a or alternatively, may be incorporated within the web server 130a. Moreover, the functions of the DPS may be provided as a software process or service executing on the web server 130a or an integral component of the web application 130b. Accordingly, when reference is made to communications from the communications portal 110 to the web server 130a, it should be understood that such references encompass embodiments in which the DPS 120 is distinct from or incorporated within the web server 130a.

The DPS receives messages from the communications portal 110 which may originate from the base station 102 or one or more collar modules 108. The information contained in the messages from the base station 102 and the one or more collar modules 108 may be transmitted to the web application 130b in separate messages or alternatively, bundled into a single message when transmitted from the communications portal 110 to the DPS or from the DPS 120 to the web application 130b. Bundling of the operational information and pet activity level and behavior information improves efficiency of communication and additionally, can provide the benefit of reducing communication costs when third party services are employed in the communication of information between the communication portal 110 and the DPS 120 or between the DPS and the web application 130b. Thus, bundled messages may be received at the web application 130b and such bundled messages may contain information that originated from various components of the animal control system 100.

A computerized device 140, as subsequently discussed in greater detail, communicates with the web server(s) 130a via a communication link 118. The computerized device 140 may comprise a desktop computer, a workstation, a laptop computer, a tablet, a mobile device such as a smartphone, or any other device capable of communication with the web server as discussed subsequently in greater detail. The communication links 116, 118 may comprise wired communications links or wireless communication links or include some link portions that are wired and other link portions that are wireless. By way of example, and not limitation, communication links 116, 118 may comprise wired or a wireless Internet links for a portion or the entirety of one or both of the communication links 116, 118. The communication links 116, 118 may employ any suitable protocol, e.g. the Ethernet protocol.

The web server(s) 130a include(s) include one or more processors, memory and non-volatile storage as known in the art and are operative to execute a web application 130b. The web application 130b is accessible by users of the computerized device 140. The computerized device 140 also includes a processor and memory and executes one or more computer programs that is/are cooperative with the web application 130b to provide the functions described herein. In one exemplary embodiment, the one or more computer programs executing on the computerized device 140 include a browser 140a that communicates with the web application 130b via Internet link 118 so as to permit a system user to interface with the web application 130b.

The base station 102 in the presently disclosed system monitors operational information pertaining to various aspects of the base station 102 and stores such information locally in a memory 212 under the control of a processor 210. Similarly, the collar module 108 monitors operational information pertaining to its operation and stores such information locally in a memory 408 within the collar module 108 under the control of a processor 406. The collar module 108 may also monitor pet activity levels and/or pet behaviors and store such information locally in the memory 408 under the control of the processor 406.

The base station 102 and the collar module(s) 108 transmit the stored information via respective transceivers over RF links 112, 114 to the communication portal 110 using an initiate-response protocol by which a sender of a message confirms that the message which was sent was received if the sender receives an acknowledgement message from the recipient within a predetermined period of time from the transmission of the original message.

The transceivers in the base station 102, collar module(s) 108 and communication portal 110 may operate at a single fixed frequency, e.g. at or about 900 Mhz, or alternatively provide frequency agility including channel (frequency) selection among a plurality of available frequencies in addition to antenna space or polarity diversity to improve communications as subsequently discussed in greater detail.

In one embodiment, the communications portal 110, transmits the operational information and activity level and pet behavior information received from the base station 102 and the collar module(s) 108 to the web server 130a from time to time. The web server 130a stores the information received from the communication portal 110 in a memory associated with the web server 130a under the control of the web application 130b executing in the web server 130a.

The operational information and pet activity and behavior information are accessible by a system user via the browser 140a executing on the computerized device 140 that communicates with the web application 130b. Additionally, the web application 130b is configured to transmit email and/or text notifications and/or alerts 130c, 130d respectively to a system user via known communication links and protocols. For example, such notification or alerts may be transmitted as email notifications or alerts 130c or as text notifications or alerts 130d communicated via conventional SMS text messaging links 130e.

A system user may also issue instructions from the computerized device 140 to modify the operation of a base station 102 or one or more collar modules 108 of the animal control system 100, e.g. via the browser 140a. More specifically, the user may access the web application 130b via the browser 140a and instruct the web application 130b to forward one or more commands to the base station 102, collar module(s) 108 and/or communications portal 110 to modify one or more of the respective device or initiate a desired action. In response to the issuance of a command by the system user to the web application 130b, the web application 130b forwards the command via communications link 118 to the communications portal 110 which relays the command as a wireless RF communication to the base station 102 or to a collar module 108.

### RF Communications Via Initiate Response Protocol

For radio frequency (RF) communications between the communications portal 110 and the base station 102 and between the communications portal 110 and a collar module 108, a two-step, initiate-response, communications scheme is used, in which a device initiates communication by transmitting an initiate message and a receiving device responds by transmitting an acknowledgement message back to the initiating device which may include information requested via the initiating device. Thus an initiating device receives a confirmation that its message was received. If an initiating device does not receive a response within a predetermined period of time following its transmission of the message, it may retry to send the message a number of times as subsequently discussed.

### The Base Station

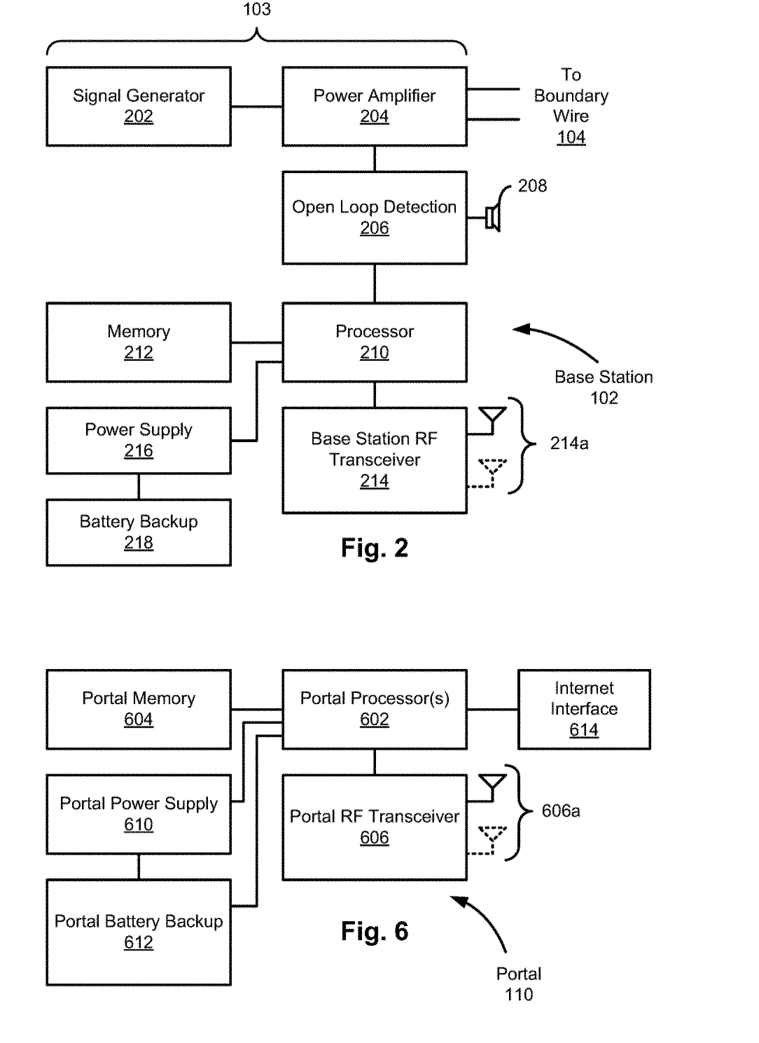

A block diagram of an exemplary base station 102, in accordance with the present invention, is illustrated in FIG. 2. The base station 102 includes a first transmitter 103 that includes a signal generator 202 for generating an RF signal having the first carrier frequency and a power amplifier 204. The output of the signal generator 202 is coupled to a power amplifier 204 which produces an RF boundary wire (fence) signal which is coupled to and transmitted over the boundary wire 104 defining the control area. In one embodiment, the boundary wire signal transmitted by the base station 102 over the boundary wire 104 is user selectable at a first carrier frequency of either 4 khz or 8 khz signal. Other suitable frequencies may be employed.

The boundary wire signal transmitted by the base station 102 may be amplitude or frequency modulated to convey configuration information from the base station 102 to the collar module(s) 108 to permit the base station 102 to set certain operational parameters within the collar module(s) 108.

The base station 102 includes open loop detection circuitry 206 that provides an open loop output signal in response to detection of a break in the boundary wire 104 or upon the detection of an unexpectedly high resistance of the boundary wire 104 such as might be observed if the wire is damaged or partially severed. Exemplary open loop detection circuity is described in U.S. Pat. No. 6,575,120 referenced above. The open loop detection circuitry 206 may be coupled to a transducer, such as a speaker 208, that provides an audible alarm in the event that a broken or defective boundary wire 104 is detected. The output signal from the open loop detection circuitry 206 may be read by a processor 210 which executes software instructions out of memory 212. An indication of the status or condition of the boundary wire 104 may be stored in memory 212 under the control of the processor 210.

The base station 102 has a plurality of user settable operational parameters that configure the operation of the base station 102 and/or the collar module(s) 108. By way of example, the base station 102 may include settable parameters such as:
transmit frequency—(e.g. 4 khz or 8 khz),
range select—(specifying the strength of the RF signal radiated by the boundary wire,
rate select—(e.g. selects a correction rate in pulses per second), and/or
mode select—(selects a sequence of audible warnings and electrical stimulus to be
employed. e.g. (i) selects a sequence having an audible warning followed by an electrical
stimulus, or (ii) selects a sequence having a electrical stimulus followed by an audible warning followed by another electrical stimulus).
   The above-referenced operational parameters are illustrative of user settable parameters employed in one embodiment of the base station 102, however, the present invention is not limited to the specifically illustrated user settable parameters. The processor 210 stores information indicative of one or more of the user settable parameters in the memory 212.

The base station 102 is powered by a power supply 216. The power supply 216 is coupled to battery backup system 218 which includes a backup battery that provides an alternative source of power to the base station 102 in the event of a power outage or a failure of the power supply 216. In this manner, the animal control system continues to function in the event of a power outage or a power supply failure. The processor 210 monitors the power supply 216 to detect a power outage, or power supply 216 failure and stores an indication of input power status in the memory 212. In the event of a power outage or a power supply 216 failure, power may be supplied for a period of time by the battery backup system 218 and the processor 210 may store in the memory 212 information indicative of the status of the backup battery within the backup battery system 218 including the backup battery voltage, the time of backup battery commenced supplying power, elapsed time running under battery backup and/or anticipated remaining time available on battery backup. Status information regarding the backup system may be monitored and stored locally in the memory 212 by the processor 210.

The processor 210 monitors the base station 102 operational information from time to time and stores such information in the memory 212 as noted above. By way of example and not limitation, the processor 210 in one exemplary embodiment monitors the user settable parameters in the base station 102, the status of the boundary wire 104, the power supply 216, the battery backup system 218 and/or any other desired parameters, characteristics or status associated with the base station 102 and stores the information in the memory 212. When operating in battery backup mode as a result of a power outage or failure of the power supply 216, the monitoring interval employed by the processor 210 may be lengthened to reduce power drain on the backup battery system 218 and thereby increase the period of time the animal control system will continue to operate while using the battery backup system 218.

Upon receipt of a query from the communications portion 110, the processor 210 generates a message that includes the stored operational information. The base station 102 includes a base station RF transceiver 214 that is communicably coupled to the processor 210. The base station 102 transmits the message via the base station RF transceiver 214 to the communications portal 110. The query in this instance represents the “initiate” portion of the “initiate-response” protocol employed by the system.

The message from the base station 102 to the communications portal 110 represents the “response” portion of the initiate-response protocol and the receipt of the response message serves as an acknowledgement that the query was successfully received by the base station 102.

As described above, the processor 210 transmits the stored operational information in response to a query, however, the base station 102 may self-initiate such transmissions in response to predetermined events or conditions observed by the processor 210 from time to time or at periodic intervals. In one exemplary embodiment, the base station 102 monitors the operational information at 100 millisecond intervals although the periodic interval at which monitoring occurs may be varied as a matter of design choice.

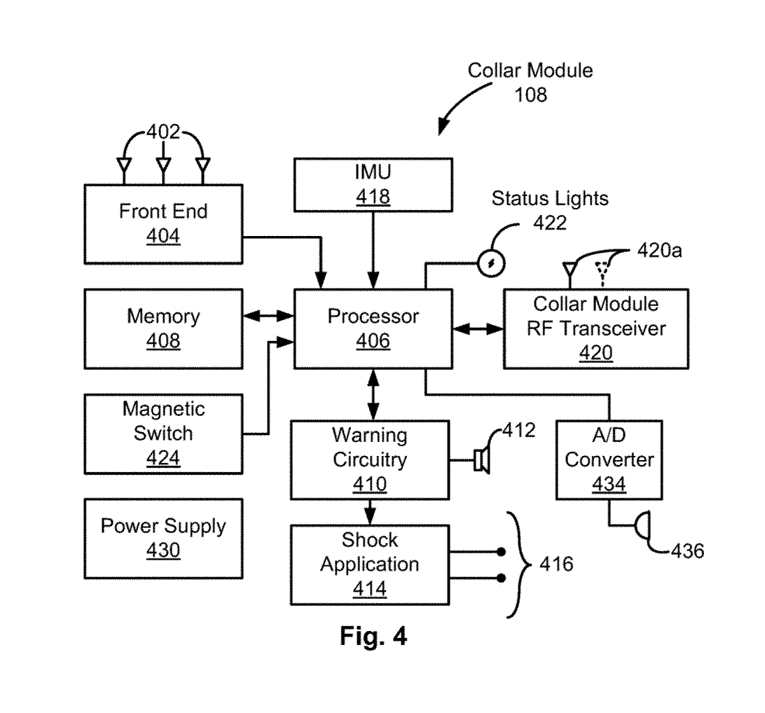

In one embodiment, command, operational and/or status information may be transmitted directly from the base station 102 to the collar module 108 via the base station RF transceiver 214 and the collar module RF transceiver 420 (see FIG. 4) using the initiate response messaging protocol described herein. Similarly, command, operational and/or status information may be transmitted from the collar module RF transceiver 420 (see FIG. 4) to the base station RF transceiver 214 using the messaging protocols described herein. Such communications may be employed to permit status indications, such as using light emitting diodes (LEDs) or otherwise, at one device based on conditions observed at the other device. For example, in response to detection of a boundary challenge or challenges by a pet, the processor 406 in the collar module 108 may initiate direct communication via the collar module RF transceiver 420 (see FIG. 4) to the base station RF transceiver 214 to convey the status reflective of the boundary challenge and an LED may be illuminated or another form of status indication may be employed to provide an immediate indication of the boundary challenge at the base station 102.

The base station RF transceiver 214 is also configured to receive commands from the communications portal 110 (FIG. 1) to provide the ability for a system user to modify user settable parameters of the base station 102 remotely via the browser 140a and the web application 130b as subsequently discussed in greater detail.

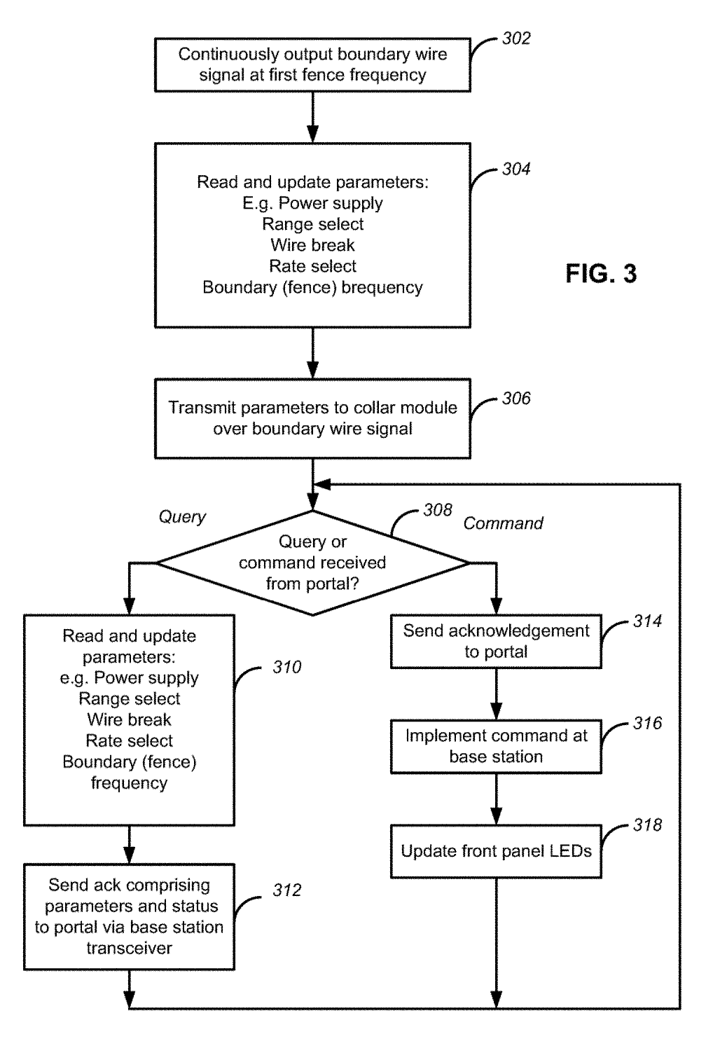

Exemplary operation of one embodiment of the base station 102 is illustrated in the flow diagram of FIG. 3. Referring to FIG. 3, as illustrated in block 302, the base station 102 continuously outputs the boundary wire signal from the power amplifier 104 as depicted in block 302 and reads and updates specified user settable parameters and status information maintained by the base station 102 as illustrated at block 304. To the extent the user settable parameters are required by the collar module 108 for compatibility or to set operational parameters in the collar module 108, data reflecting such parameters are encoded on the boundary wire signal, such as by frequency or amplitude modulation of the boundary wire signal as depicted at block 306.

As illustrated at decision block 308, the base station 102 awaits receipt of a query or a command from the communications portal 110. If the base station 102 receives a query from the communications portal 110, the processor accesses or rereads the operational parameters and status of the base station 102 and transmits a message that includes such information to the communications portal 110 via the base station RF transceiver 214 under the control of the base station processor 210 as depicted at block 312. The transmission of the message containing the base station operational parameters and status constitutes the acknowledgement and response to the initiating query of the initiate-response protocol. The information may be transmitted using a single carrier frequency (the second carrier frequency) or alternatively, the frequency at which the information is transmitted to the communications portal 110 may be selected from one of a plurality of channels (frequencies) as subsequently discussed.

If it is determined by the base station processor 210 that a command has been received from the communications portal 110, at decision block 308, the base station 102 sends an acknowledgement to the communications portal 110 indicating the receipt of the command as depicted at block 314. The base station 102 implements the command under the control of the processor 210 by modifying one or more operational parameters or by performing an action specified by the command. If the command to the base station 102 also requires modification of the operation of the collar module 108, the base station 102 may forwards the operational parameter to the collar module 108 by encoding the same on the boundary wire signal as previously discussed depending on the operational parameter involved.

In the event the modification of any operational parameters and/or status information affects any status indicators, e.g. LEDs or display information, at the base station 102, the status indicators are updated to reflect the current information or status.

Following response to a query or command received at the base station 102 control returns to block 308 and the processor 210 awaits a further query or command.

The Collar Module(s) FIG. 4 is an exemplary block diagram of a collar module 108 that is affixed to a collar 106 worn by a pet. The collar module 108 includes a first receiver 401 which includes antennas 402 and front end circuitry 404. The antenna(s) 402 receive(s) the radiated boundary wire RF signal transmitted by the base station 102 at the first carrier frequency over the boundary wire 104. Front end circuitry 404 filters and amplifies the received RF boundary wire signal. The collar module 108 further includes a processor 406 and memory 408. The processor 406 is operative to execute a computer program stored in the memory 408 to provide the functionality herein described.

In one embodiment, the processor 406 decodes the received RF boundary wire signal to determine whether any operational parameters in the collar module 108 should be set in accordance with the encoded information. The processor 406 also decodes information encoded on the boundary wire signal to determine if the received signal is valid. The strength of the boundary wire signal is used by the collar module 108 to determine if a stimulus should be provided.

The collar module 108 further includes a warning circuit 410 that is coupled to an audible or vibratory transducer 412. The warning circuit 410 includes a buffer/amplifier for driving the transducer 412. For example, the transducer 412 may comprise a speaker, a piezoelectric device or any other form of audible or vibratory transducer that may be employed to provide a stimulus to a pet. Under control of the collar module processor 406, the warning circuit 410 activates the transducer 412 to provide a stimulus to the pet in response to a determination by the collar module processor 406 that the pet is sufficiently proximate the boundary wire 104 as to warrant a stimulus. The collar module 108 further includes shock application circuitry 414, which, when enabled, provides an electrical stimulus (shock) to the pet through electrodes 416 that extend through the collar so as to be proximate the skin of the pet. The electrical stimulus serves to train the pet to retreat from and not approach the boundary wire 104 that defines the control area. An electrical stimulus may also be provided for purposes of bark correction should it be determined that the pet's barking is problematic. The collar module 108 may also include a microphone 436 and/or an Inertial Measurement Unit (“IMU”) which may be employed to detect barking by a pet. More specifically, the processor 406 may detect the amplitude and number of barks within a predetermined period to determine whether a bark correction stimulus should be automatically employed. An analog to digital converter 434 converts the microphone 436 output to a digital signal which is sampled by the processor 406 to generate data representative of barking events. The data is stored in the receiver memory 408. Additionally, a time at which barking events occur may be stored in the memory 408.

The output of the IMU 418 is coupled to the processor 406. The IMU may comprise one or more accelerometers, magnetometers, gyroscopes or combinations thereof. The processor 406 samples the IMU 418 output at periodic intervals to produce a profile of the pet's activity level and/or pet behavior. The processor 406, may reduce the sampling frequency of the IMU to conserve battery power based on specified criteria. For example, following the transmission of operational information to the communications portal 110, the processor 406 may reduce the clock frequency to reduce power consumption for the duration of the period until the processor 406 will again monitor and transmit operational information to the communications portal 110. Additionally, by way of example, if the processor 406 determines that the pet is inactive, e.g. resting, the processor 406 may reduce the sampling frequency of the IMU.

The processor 406 may also store in the memory 406 data that indicates that the pet challenged the boundary, the time of the boundary challenge, and the nature of the stimulus provided to the pet.

The processor 406 is coupled to the collar module RF transceiver 420 which may transmit RF signals via a single antenna 420a or via 2 or more antennas 420a while employing channel selection and transmit antenna spatial or polarity diversity as subsequently discussed.

Under the control of the processor 406, the collar module 108, from time to time, transmits a message via the collar module RF transceiver 420 to the communications portal 110 that includes operational information and/or activity level and pet behavior information. By way of example, the activity level information may include information reflective of pet movement and behavior information may include information pertaining to barking and/or boundary wire 104 challenges.

The collar module 108 further includes a magnetically actuatable switch 424 that is coupled to and monitored by the processor 406. When a magnet is placed proximate to the magnetically actuatable switch, the switch is actuated. In response, the processor 406 adjusts the nature and level of the stimulus to be provided to the pet. More specifically, the processor 406 cycles through available stimulus options and provides one or more audible beeps that are associated with the respective stimulus selections. In one embodiment, when a magnet is placed adjacent the collar 106, the collar module 108 initially emits a series of beeps that audibly identify the then current stimulus level. If the magnet is held adjacent the collar 106 so as to maintain actuation of the magnetically actuatable switch, the stimulus level advances through a series of available stimulus options and emits a corresponding number of audible beeps associated with each option. To select one of the stimulus options the magnet is moved away from the collar 106 and the processor 406 selects the then specified stimulus option. By way of example, an audible only stimulus may be associated with one long beep, a first level electrical stimulus option may be associated with one short beep, a second higher level electrical stimulus option may be associated with two short audible beeps, a third even higher electrical stimulus option may be associated with three short audible beeps, etc.

While the selection technique discussed immediately above is described in terms of the use of a magnet in conjunction with a reed switch, it will be understood that such functionality may be provided using a button, a switch or any other selection techniques known in the art.

A status light 422 is coupled to the signal processor 406. While setting the stimulus level as described immediately above, the status light flashes in conjunction with each audible beep. The number of flashes/beeps identifies the selected stimulus level for the collar module 108.

The collar module 108 is powered by a power supply 430 which comprises a battery. Since the collar module 108 is battery powered, power conservations techniques are employed to extend the life of the battery as subsequently discussed.

At times determined by the processor 406, the collar module 108 forwards stored operational information and pet activity level and behavior information to the communications portal 110. In this respect, in one embodiment, the collar module 108 operates as a master and does not transmit stored information in response to regular periodic queries to preserve battery power. By way of example, the processor 406 in the collar module 108, during some periods, conveys stored information to the communications portal 110 at periodic intervals; e.g. 1 minute, 10 minute, 1 hour intervals or any other suitable interval. The frequency at which such information is communicated to the portal 110 may be reduced in response to predetermined conditions or events to conserve battery power. By way of example, and not limitation, in the event there has been no change in the status of one or more selected parameters within a specified period, the frequency of monitoring of such parameters, and/or the frequency at which the processor operates and/or transmits information to the communication portal 110 may be reduced to reduce power consumption.

The collar module 108, in another embodiment, may respond to queries for information issued by the communications portal 110 as described above with respect to the base station 102, recognizing that frequent queries of the collar module 108 may adversely affect battery life.

In response to a command received from the communications portal 110, the collar module 108 may modify its operational parameters so as to change its operation or transmit information from the collar module 108 to the communications portal 110.

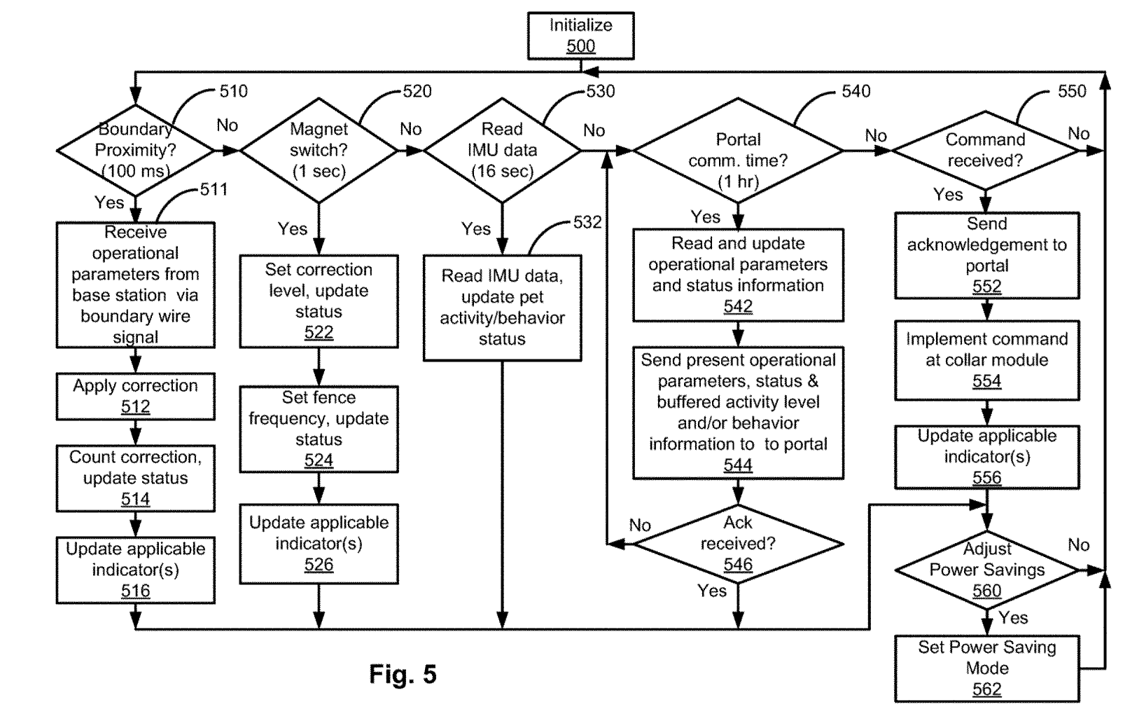

FIG. 5 illustrates the operation of one embodiment of the collar module 108. As illustrated in FIG. 5, basic initialization functions are performed. Thereafter, in the illustrated embodiment, the collar module 108 performs specific functions at predefined intervals or in response to specified conditions.

More specifically, as depicted at decision block 510, the processor 406 determines whether the collar module 108 is sufficiently proximate the boundary wire to receive the boundary signal. If this inquiry is answered in the affirmative, the collar module 108 receives operational parameters from the base station 102 via the boundary wire signal as depicted in block 511 and, if the pet is sufficiently proximate to the boundary wire 104, a stimulus or correction is applied to the pet. If a stimulus is applied to the pet, a count of the number of corrections is updated along with stimulus status information as illustrated block 514 and application indicators, such as visible LED indicators of the collar module 108 are updated as illustrated at block 516. Control then passes to decision block 560 to determine if the power savings mode should be adjusted. In one embodiment, the periodic interval at which the collar module receives encoded information when sufficiently close to the boundary wires is 100 milliseconds although the interval is a matter of design choice.

If the test of proximity of the collar module 108 to the boundary wire 104 indicates that the collar module 108 is not sufficiently proximate the boundary wire 104, control passes to decision block 520.

The collar module 108 also determines whether a magnet has been placed physically proximate a reed switch as illustrated at decision block 520. In one embodiment, this test is performed periodically at one second intervals although the interval at which to perform this determination is a matter of design choice. If this inquiry is answered in the affirmative, the correction level within the collar module 108 may be set and the status updated as depicted at block 522. Additionally, the fence frequency may be set, the status updated as illustrated at block 524 and any applicable indicators affected by the updates are also updated to reflect the current status of the updated parameters as depicted at step 526. Control then passes to decision block 560 to determine whether the power savings mode should be adjusted.

If the test of the magnetic switch results in a determination that a magnet is not present, control passes to decision block 530.

The collar module 108 also determines whether to read IMU data. If the collar module processor 406 determines that it is time to read the IMU data, the IMU output is read. The IMU output signal provides information indicative of the pet activity level and/or behaviors. The IMU output data is stored in collar module memory 408. Control them passes to decision block 560 to determine whether the power savings mode should be adjusted. In one embodiment, the interval at which the IMU data is read is 16 seconds, although the time interval is a matter of design choice.

If the collar module processor 406 determines that the interval at which the IMU data should be read has not elapsed, control passes to decision block 540.

The collar module processor 406 determines whether the time has elapsed at which the collar module 108 reports operational information, pet activity level and behavior information to the communications portal 110 as depicted at decision block 540. In one embodiment, the collar module 108 forwards such information to the communications portal 110 at one (1) hour intervals although the interval at which such reporting occurs represents a trade-off between the desirability for infrequent reporting from the collar module 108 to the communications portal 110 to prolong receiver battery life versus the desirability of maintaining current information pertaining to the system components and the pets being monitored at the web server 130a. If the collar module processor 406 determines that the time interval at which reporting to the communications portal 110 has elapsed, the processor 406 reads and updates the current operational information from the collar module memory 408 as depicted at block 542 and transmits the operational information, buffered pet activity level information and pet behavior information to the communication portal 110 via the collar module RF transceiver 420 as illustrated at block 544. The message conveying such information constitutes the initiate portion of the initiate-response protocol. The collar module processor 406 then awaits receipt of an acknowledgement as depicted at decision block 546. If an acknowledgement is received, control passes to decision block 560. If no acknowledgement is received by the collar module 108 within a predetermined period of time, control returns to decision block 540 and a determination is made whether to retry the transmission of collar module information to the communications portal 110. If the retransmission is not to be reattempted (though not illustrated in FIG. 5) control passes to decision block 560.

If the collar module processor 406 determines that it is not time to transmit collar module information to the communication portal 110, as illustrated at decision block 540, control passes to decision block 550.

As depicted at decision block 550, the collar module processor 406 determines whether a command has been received that needs to be processed. If a command has been received, as depicted at block 552 an acknowledgement of the receipt of the command is forwarded to the initiating device, e.g. the communications portal 110. The collar module processor 406 then implements the command received from communications portal 110 which may involve modifying one or more operational parameters of the collar module 108 as illustrated at block 554. By way of example and not limitation, the command may alter the strength of an electrical stimulus provided to the pet, the receive frequency for the boundary wire signal, or any other user settable parameter associated with the collar module 108. The processor 406 then updates any applicable indicators, e.g. LEDs, at the collar module 108 that are affected by the changed parameter (s) as depicted at block 556.

As illustrated at decision block 560, the processor 406 determines whether to adjust a power savings mode in the collar module 108. If it is determined to adjust the power savings mode, either to reduce power consumption or to resume full speed operation, the power savings mode is appropriately adjusted as depicted at block 562. For example, after transmitting its information to the communications portal 110, the collar module 108 may enter a power savings mode in which it reduces the clock speed of the processor 406, shuts down power to portions of the collar module 108 or engages in other modifications to the collar module to reduce power drawn from the battery to prolong receiver battery life. After adjusting the power savings mode, control returns to decision block 510.

The Communications Portal

FIG. 6 is a block diagram of the communication portal 110. The communications portal 110 includes a portal processor 602 that is coupled to a portal memory 604. The portal processor 602 may comprise a single processor or a plurality of processors. In one embodiment, one processor is responsible for controlling transmissions via the portal RF transceiver and another processor preforms conventional data processing functions. When two or more processors are employed, collectively, they serve as the processor 602.

The portal processor 602 is configured to execute a software program out of the portal memory 604 to implement the functions described herein. The portal processor 602 is coupled to a portal RF transceiver 606 having one or more antennas 608a. Plural antennas are provided when spatial or polarity antenna diversity is supported. The portal RF transceiver 606 receives operational information from the base station 102 and the collar module 108 via wireless RF links 112, 114 as described above and also receives pet activity level information and pet behavior information from the collar module 108.

The communications portal 110 includes a power supply 610 and may optionally include a battery backup system including a backup battery that provides power for the portal 110 in the event of a power outage or a failure of the portal power supply 610.

Operational information pertaining to the communications portal 110 may also be monitored by the portal processor 602, stored in the portal memory 604 and transmitted to the web server 130a to permit access to such information by a system user via the web application 130b. By way of example, the status of the power supply and/or a portal backup battery 612 may be monitored and conveyed to the web application 130b separately from, or in conjunction with the information relayed from the base station 102 and the collar module 108.

The communications portal 110 receives the operational information from the base station 102 and the collar module 108 and pet activity level and behavior information from the collar module 108 as discussed with respect to FIG. 5 and stores the received information in the portal memory 604. The communications portal 110, under the control of the processor 602 transmits the received information to the web server 130a via a network interface, e.g. an Internet interface 614, for storage and processing by the web application 130b.

The Internet interface 614 may be implemented as a wired interface or, alternatively, as a wireless interface for connection to the Internet via a wireless link which may include a WiFi link. The base station 102, collar module(s) 108 and communication portion 110 each include an RF transceiver to permit wireless communications therebetween. The transceivers may be implemented as a single functional component that is operative to transmit and receive RF signals or, alternatively, as distinct transmitters and receivers. Thus, the base station 102 includes a first RF transmitter that transmits a first RF signal at a first carrier frequency for receipt by a receiver in the collar module 108 and additionally, the base station 102 includes a second RF transmitter that transmits a second RF signal at a second carrier frequency for receipt by the portal RF transceiver 606. Additionally, the collar module 108 includes a receiver that receives the first RF signal at the first carrier frequency transmitted from the base station 102 and includes a collar module RF transmitter that transmits an RF signal at the second carrier frequency for receipt by the portal RF transceiver 606. Furthermore, the portal RF transceiver 606 includes a portal RF transmitter that transmits portal RF signals at the second carrier frequency for receipt by the receivers of the base station transceiver 214 and the collar module RF transceiver 420, respectively. In one embodiment, the second carrier frequency is greater than the first carrier frequency.

In one embodiment, the functions of the communications portal 110 are performed by a mobile device, e.g. a smart phone, a table or any other such mobile device. In this embodiment, the base station 102 and the collar module(s) 108 communicate with the mobile device functioning as the communications portal 110 when the mobile device is within range of the base stations 102 or collar module(s) 108. The RF links from the mobile device to the base station 102 and the collar module(s) may be via Bluetooth™ or WiFi or any other suitable RF protocol. In one embodiment, the mobile device communicates operational information and pet activity level information and pet behavior information to the web server 130a via a cellular network. In certain situations, due to the size of a controlled area, a plurality of base stations 102 are employed to transmit boundary signals over a corresponding plurality of boundary wires to cover the desired area(s). In such a circumstance the plurality of base stations 102 and all collar module(s) associated with the multiple base stations 102 may be served by a single communications portal 110.

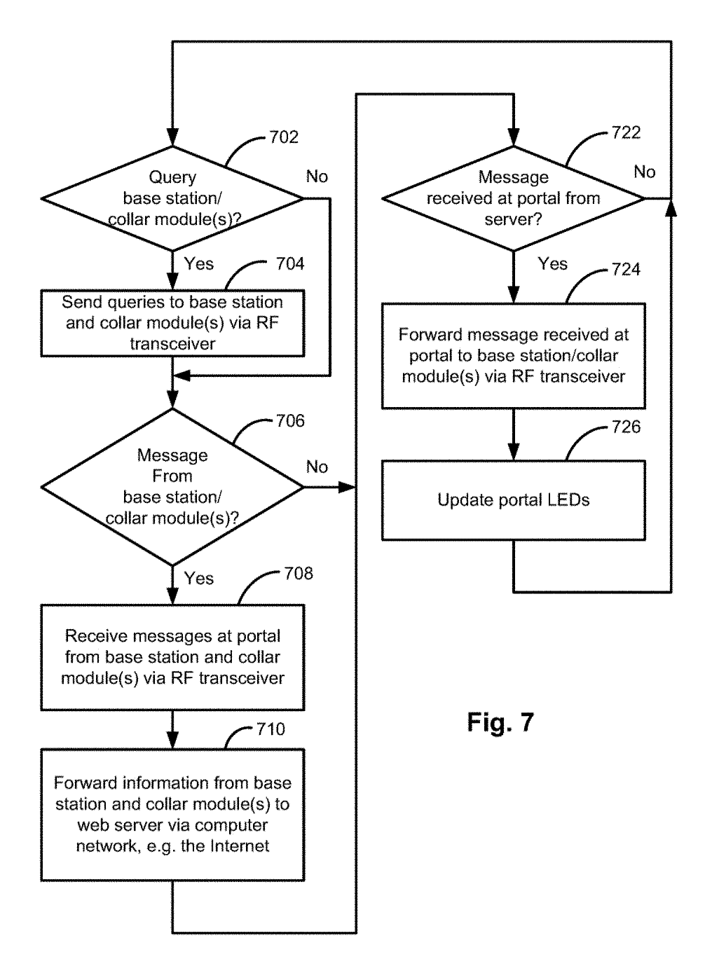

FIG. 7 is a flow diagram illustrative of the operation of one embodiment of the communications portal 110. As depicted in decision block 702, the portal processor 602 determines whether to issue a query to the base station 102 and/or one or more receivers 108. In one embodiment, as noted above, the communications portal 110 only issues queries to the base station 102 and the collar module 108 self-determines when to transmit its information to the portal 110. The portal processor 602 may determine that a query should be issued upon the expiration of a periodic interval or in response to a command issued by a system user and conveyed via the web application 130b. In one embodiment, the communication portal 110 issues queries to the base station 102 at one minute intervals.

If the portal processor 602 determines that a query should be issued as illustrated at decision block 702, the query is forwarded to the base station 102 or collar module 108, as applicable. The query is addressed to the respective device using the unique ID or address associated with the intended recipient of the query as depicted at block 704.

The portal processor next 602 determines whether a message has been received in response to the query as illustrated at decision block 706. In one embodiment, a collar module 108, as noted above, initiates transmission of information including operational information and pet activity level and behavior information autonomously and not in response to a portal query. If the communications portal 110 receives the information in response to a query or via a transmission initiated by a base station 102 or collar module 108 as depicted at block 708, the received information is forwarded by the communications portal 110 to the web server 130a via a computer network, e.g. the Internet, as illustrated at block 710 and control passes to decision block 722 to determine whether the communications portal 110 has received a message, e.g. a command, from the web server 130 to be conveyed to the base station 102 or a collar module 108.

When the communications portal 110 receives a message from a collar module 108, the collar module 108 is not operating in a power saving mode. Accordingly, rather than sending a bare acknowledgement of the receipt of information by the communications portal 110, if the communications portal 110 has a message to transmit to the respective collar module 108, it may incorporate that message in the acknowledgement returned to the collar module 108 to reduce the number of communications with the respective collar module 108 since additional messaging adversely affects collar module 108 battery life. In the event that the communications portal 110 incorporated a message, e.g. a command, with an acknowledgement sent to a collar module 108 or the base station 102, the communications portal 110 would await receipt of an acknowledgement from the collar module 108 or the base station 102, as applicable, to confirm receipt of the message (command).

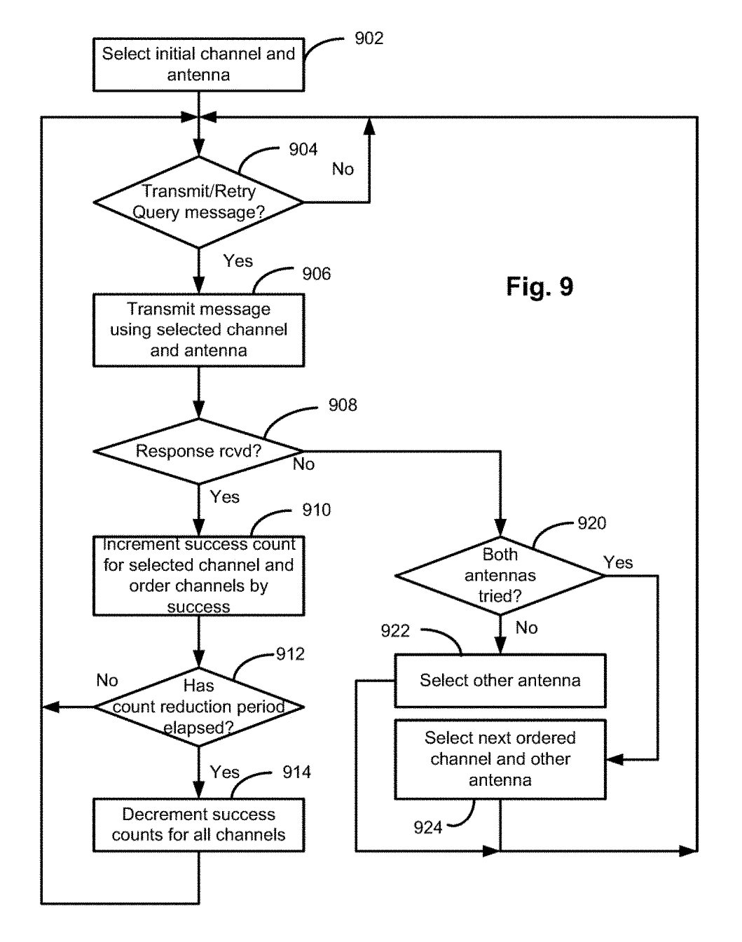

If a query is forwarded to a base station 102 or collar module 108 and no response is received within a predetermined period of time, in one embodiment, control passes to decision block 722. In another embodiment, the communications portal 110 may retry the query employing a channel selection technique with or without antenna diversity as described in greater detail with respect to FIG. 9.

At decision block 722, the portal processor 602 determines whether a message, e.g. a command, has been received from the web server 130a. A command may be received at the communications portal 110 from the web server 130 to cause the communications portal 110 to instruct the base station 102 or a collar module 108 to modify one or more operational parameters or settings or to transmit their then current information to the communications portal 110. In this manner, a system user may interrogate a base station 102 or collar module 108 through the web application 130b accessible via the browser 140a executing on the computerized device 140. If the communications portal 110 determines that a message has been received from the web server 130a that is destined for the base station 102 or a collar module 108, it transmits the message via the portal RF transceiver 606 addressed to the unique ID of the respective device. If the message involves the status of any information reflected on portal LEDs or a status indicator, such is updated as depicted at block 726 and control returns to block 702.

The communications portal 110 may forward commands to the base station 102 to perform various functions via a modulated RF signal at the second carrier frequency addressed to the unique identifier of the base station 102. By way of example and not limitation, the communication portal may forward a command to the base station 102 to change the first carrier frequency transmitted over the boundary wire 104 by the base station 102, cease transmission of the first modulated RF signal to negate the pet control or containment function, disable all base station 102 functions except for the ability to receive communications from the communication portal to re-enable disabled base station 102 functions, re-enable disabled functions of the base station 102, change a power level of the first modulated RF signal transmitted by the first base station transmitter 103 to modify a distance from the boundary wire 104 at which a stimulus is generated by the collar module 108, change a value indicative of a pulse rate of an electrical stimulus, change data indicative of a sequence of one or more audible warnings and an electrical stimulus, and/or return a value to the communications portal 110 indicative of time remaining for operation on battery backup power.

Additionally, the communications portal 110 may forward commands to the collar module 108 to perform various functions via a modulated RF signal at the second carrier frequency addressed to the unique identifier of the collar module 108. By way of example and not limitation, the communication portal may forward a command to the configure the collar module 108 to receive a modified first RF carrier frequency that corresponds to a modified first carrier frequency transmitted by the first base station transmitter 103, modify an interval between transmissions of operational data from the collar module 108 to the communications portal 110, disable the collar module 108 from generating one or both of an audible and electrical stimulus, change a strength of an electrical stimulus to be generated by the collar module 108, modify a characteristic of an audible or electrical stimulus to be provided to a pet, change an operational mode of the collar module 108 from activity level tracking to bark detection or from bark detection to activity level tracking, forward at least pet activity level data to the communications portal 110, and/or forward at least pet behavior data to the communications portal 110.

The above-described commands transmitted by the communications portal 110 to the base station 102 and/or collar module 108 are intended to be illustrative. In addition, it is contemplated that the communications portal 110 may transmit other types of commands to the base station 102 and/or the collar module 108.

The communications portal 110 may also respond to commands addressed to a unique identifier associated with the communications portal 110. The commands may be initiated by a system user via the web server 130a where the system user is communicating with the web server 130a via the computerized device 140. By way of example and not limitation, the communications portal 110 has an associated unique identifier and is configured to maintain in the communication portal memory 604 one or more logs of prior communication portal actions. In one embodiment the communications portal 110 is configured to receive a command via the network interface 614 from the web server 130a or the device protocol server 120 that is addressed to the communication portal 110 unique identifier to transmit a communication portal log to a specified destination address for diagnostic purposes. By way of example, the communication portal logs may include messages or events in the syslog format generated within the Linux (tm) operating environment. In response to receipt of a command to return one or more logs, the communications portal 110 retrieves the logs and transmits the logs to a specified destination address.

The communications portal 110 may also respond to a command to modify a time interval between queries to the base station 102 for operational data. The communications portal 110 stores in the communications portal memory 604, a value indicative of a base station query interval. The base station query interval in the length of time between queries transmitted from the communications portal 110 to the base station 102 that request the base station 102 to return base station operational data. In response to a command to modify the value of the query interval received via the network interface and addressed to the unique identifier associated with the communications portal 110, the communications portal 110 stores a modified query interval included within the command message in the communications portal memory 604 and transmits subsequent queries from the communication portal 110 to the base station 102 in accordance with the modified query interval.

### Unique Device IDs

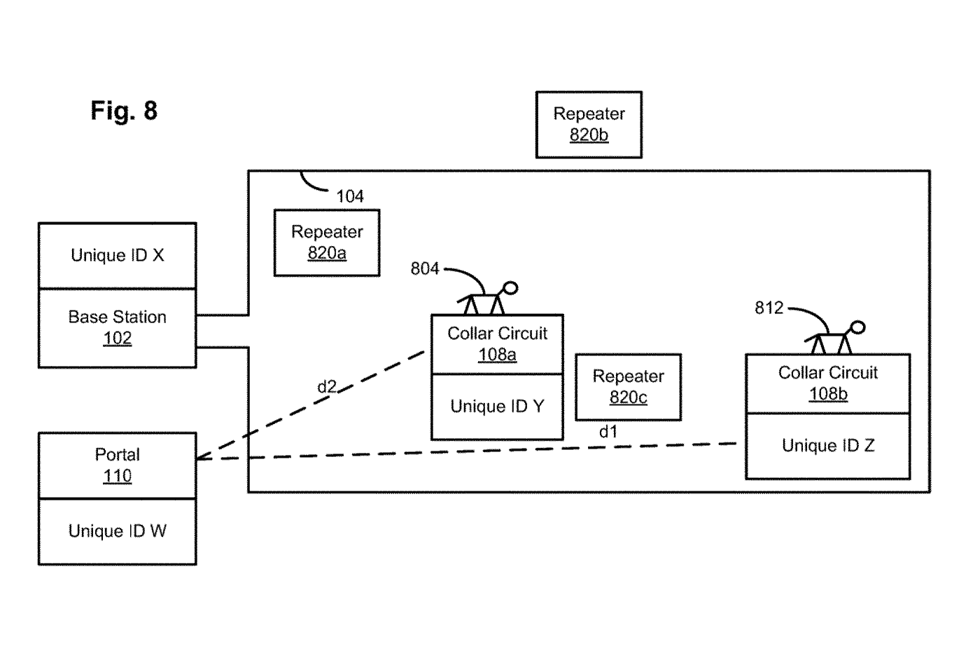

FIG. 8 depicts a pet containment area surrounded by boundary wire 104 with a base station 102 coupled to the boundary wire 104 and two collar modules 108a, 108b disposed within the containment area. The base station 102 and collar modules 108a, 108b may communicate bi-directionally with the communications portal 110 via their respective RF transceivers. The base station 102, the collar module(s) 108 and the communication portal 110 are each associated with a unique ID which allows information obtained from the base station 102 or the respective collar module 108 to be associated with the sourcing device by the web application 130b. Consequently, information accessed by a system user through the web application 130b may be associated with a specific device, e.g. base station 102, collar module 108 and/or communications portal 110. Moreover, by knowing a unique ID is associated with a specific collar module 108, the system user may also associate pet activity level and pet behavior information with a specific pet if more than one pet is being monitored. Accordingly, if multiple pets are confined within a single pet containment area, the information obtained from each collar module 108 may be associated with a particular collar module 108 and the corresponding pet using the unique ID associated with the respective collar module 108. Additionally, since each component in the pet containment system has a unique ID, messages may be addressed by one component of the pet containment system to another component of the system by the unique ID and operational information of any component of the animal control system may be addressed and transmitted to any other component of the animal control system using the destination's unique ID as the destination address and the source unique ID to identify the source of the transmitted information.

In large pet containment areas, if a pet is located far from the communications portal 110, the communication range of the collar module RF transceiver 420 may be inadequate to communicate with the communications portal 110. To address this potential problem one or more repeaters, e.g. repeaters 820a, 820b, 820c may be positioned within the control area or in the vicinity of the control area so as to permit messages to be communicated from a collar module 108a, 108b to the communications portal 110 that could not otherwise be then forwarded. In one embodiment, repeaters 820a, 820b, 820c forward all messages received from a collar module 108 having a unique ID associated with the respective pet containment system 100. In another embodiment, the repeaters 820a, 820b, 820c only forward messages for which no acknowledgement has been received at a collar module 108 attempting to communicate with the communications portal 110. Repeaters, like other pet containment system components, are assigned unique IDs. Messages retransmitted by repeaters include the unique ID of the originating collar module 108 so that information contained within the retransmitted message may be associated with the respective collar module 108 and/or the associated pet. Additionally, a message that is retransmitted by a repeater may include an indication of the unique ID of the respective repeater that retransmitted the message and/or an indication that the message was forwarded from a repeater.

The function of a repeater described above, may be performed within a standalone repeater or alternatively incorporated in one or more collar modules 108 of an animal control system 100 in which plural collar modules 108 are in use. If one pet, e.g. pet 812 having a first collar module 108b is located within the control area sufficiently remote from the communications portal 110 at a distance d1 that it cannot communicate directly with the communications portal 110, but another pet, e.g. pet 804, having a second collar module, e.g. collar module 108a, is at a distance d2 within communication range of both the first collar module 108b and the communications portal 110, the second collar module 108a may serve as the repeater and provide the repeater functionality described above.

Thus, repeater functionality may be provided either as one or more fixed devices such as illustrated by repeaters 820a, 820b, 820c. This involves additional cost since additional components are required and additional infrastructure may be required if the repeaters are not battery or solar powered. If the repeater functionality is incorporated within collar modules 108 such additional costs are avoided. Any number of repeaters may be provided as either standalone devices or as functionality provided within collar modules 108.

### Portal Filtering

A plurality of animal control systems may be located within a given vicinity giving rise to the possibility that a communications portal 110 in an animal control system may receive messages transmitted by RF transceivers of base stations, collar modules and communications portals from other animal control systems. To avoid burdening the web server 130a and the web application 130b with the processing of extraneous data and messages unrelated to the operation and pets in the system of interest, filtering of messages may be performed by unique ID at the communications portal 110 so that only information pertaining to devices having unique IDs within the given animal control system of interest are forwarded by the communications portal 110 to the web server 130a.

Frequency Agility

For radio frequency (RF) communications between devices, channel-based frequency agility may be used to avoid interference by foreign devices. In one embodiment a four-channel frequency agility scheme is employed, however any number of channels may be used.

A device initiating communications is responsible for determining a frequency channel (active channel) to be used. A receiving device scans all channels during a message preamble and selects the channel frequency in use before a preamble ends. Once the preamble ends, a message data segment follows and, with a channel frequency selected, a receiving device can read the information contained within the data segment of the message. When a receiving device responds to an initiating device with a response, the receiving device uses the same channel it selected while scanning the preamble for transmission of the response. Thus the initiating device determines the channel to be used for the communication and the subsequent response from the receiving device occurs on the same frequency channel.

An initiating device chooses the active channel based on past communications channels that have resulted in the successful receipt of a response. An initiating device keeps a record of successful responses for a channel in a channel list. The channel list is ordered by success counts. Over time, each entry in the channel list accumulates a count of the number of successes. Each time a channel's success count in the list is changed, the channel list is reordered if necessary, with the active channel being the first element on the list. The second element in the list is the non-active channel with the next highest success count. A channel's accumulated success count is a reflection of the quality of communication for that channel frequency. To bias the channel choice toward recent successes, all success counts in the channel list are periodically reduced. The reduction is a way to age the counts such that recent successes are weighted higher than successes in the distant past.

Active Channel Selection

An initiating device will stay on a channel and accumulate counts for that channel as long as the communications using that channel frequency are successful (a response is received). An attempted communication may be optionally retried a predetermined number of times for each channel, if an attempted communication is unsuccessful. When an initiating device does not receive a response (a miss) and, the predetermined number of retries have been attempted, or retries are not being employed, the initiating device selects the next channel in the ordered channel list as the active channel. Since the list is prioritized by success count, the next channel in the list is the next most successful channel. After retries for communications on a given channel frequency, an unsuccessful attempted communication (a miss) results in the selection of the next channel on the ordered channel list. When the end of the channel list is reached, the first element on the channel list is again selected. Thus repeated misses will result in rotating through all the channels on the list repeatedly.

### Transmit Two-Antenna Space or Polarity Diversity

Transmit antenna diversity enhances a system's ability to communicate when using radio frequencies. Active Channel Selection may be employed with or without antenna diversity. To implement antenna diversity, the initiating device initially selects one of plural antennas to use for an attempted communication. In the instant example, a system that employs two antennas is described. Antenna diversity may be employed with two or more antennas. For purposes of illustration, antenna diversity is discussed herein in an embodiment having two antennas.

Active channel selection and antenna diversity as described herein may be utilized in the communications portal 110, the base station 102, the collar module(s) 108 and/or one or more repeaters (e.g. repeaters 820a, 820b, 820c). In one embodiment, the communications portal 110 includes one antenna within a communications portal housing and one antenna external of the housing, the collar module(s) 108 include one antenna disposed within a collar module housing, and the base station 102 includes one antenna disposed within a base station housing. It is contemplated, however, that the base station 102, collar module(s) 108, communication portal 110 and/or repeaters may each include any number of internal and external antenna, a plurality of internal or external antennas or a single antenna if antenna diversity is not to be employed.

To improve communications, the system may employ Active Channel Selection described above in combination with transmit antenna diversity in which each antenna is selected and used for each channel that is selected. By way of example, in a system employing two-antenna diversity, the following sequence is performed:
1. A first channel and a first antenna is initially selected
2. After a miss the first channel is used however the second antenna is selected.
3. On the next miss the next channel is used and the first antenna is selected.
4. On the next miss, the same channel is used and the second antenna is selected.
5. Steps 3 and 4 repeat to cycle through channels and antennas.

Antenna diversity employed in the presently disclosed animal control system 100 may be provided using polarity diversity or space diversity. When two antenna polarity diversity is employed, antennas in the initiating device are configured to provide different polarizations, e.g. orthogonal. When space diversity is employed, two or more antennas, usually with the same characteristics, are physically separated from one another. Depending upon the expected incidence of the incoming signal, a spatial separation on the order of a wavelength may be sufficient. Larger separation distances may be needed.

In one embodiment of the disclosed system, only the communications portal 110 employs active channel selection using antenna diversity. It should be recognized however, that the base station 102, collar module 108 or communications portal 110 may employ active channel selection alone, or in combination with antenna diversity.

FIG. 9 illustrates operation of a device in accordance with the present invention that performs active channel selection and employs antenna diversity. The base station 102, the collar module(s) 108 and/or the communication portal 110 may perform channel selection and/or include the ability to provide antenna diversity as presently described.

Referring to FIG. 9, a device initially selects a channel (frequency) for the initial transmission and one of the two antennas as depicted in block 902. The device next determines whether it should transmit a message, such as a query message, a command, or retry sending a query message or a command following non-receipt of an acknowledgement. By way of example, the communications portal 110 may determine that it is time to transmit a periodic query message to a base station 102. If the initiating device (e.g. the communications portal 110) determines that it is time to transmit a message, the message is transmitted by the initiating device using the selected channel and antenna as illustrated in block 906.

As depicted in step 908, the initiating device next determines whether a response to the message transmitted per block 906 has been received. If no response has been received within a predetermined time (a miss), the initiating device determines whether attempts to transmit the message with each of the antennas using the same channel have occurred as depicted in decision block 920. If attempts to transmit using each of the antennas have been made, the next channel in the ordered channel list is selected and the other antenna of the two antennas is selected. Control passes to decision block 904 and a determination is made whether there is a message to transmit. In the case of a retry resulting from a miss, the initiating device will determine that there is a message (retry message) to transmit per decision block 904.

If it is determined that attempts to transmit the message by the initiating device have not occurred with both antennas in decision block 902, the other antenna is selected as illustrated in block 922 and control returns to decision block 904.

If the initiating device determines that a response to the initial message was received within the predetermined time period per decision block 908, the initiating device increments a success count associated with the respective channel and antenna and reorders the channel list, if necessary, as depicted at block 910.

Per decision block 912, the initiating device determines whether a count reduction period has elapsed. If the count reduction period has not elapsed, control returns to decision block 904 and the initiating device awaits a determination that another message should be transmitted. If the count reduction period has elapsed, the success counts associated with all channel selections are decrements as depicted at block 914. Decrementing the success counts has the effect of biasing the ordered list toward the channel and antenna selections that have been successful most recently. Following the decrementing of success counts in the ordered channel list, control returns to decision block 904 to await a determination that another message needs to be transmitted by the initiating device.

### The Device Protocol Server (DPS) and Web Application

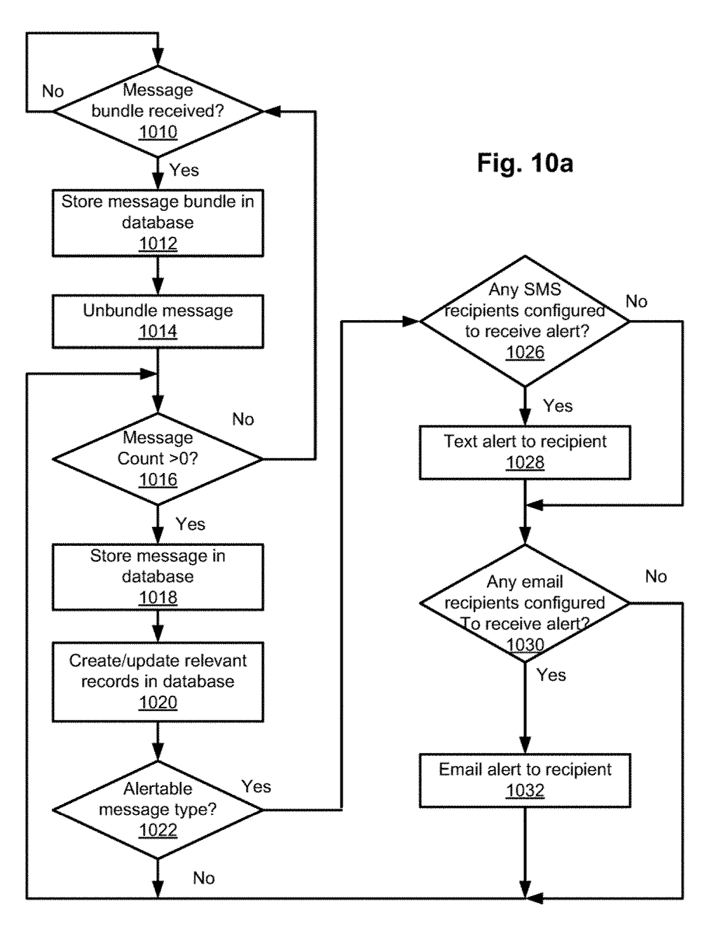

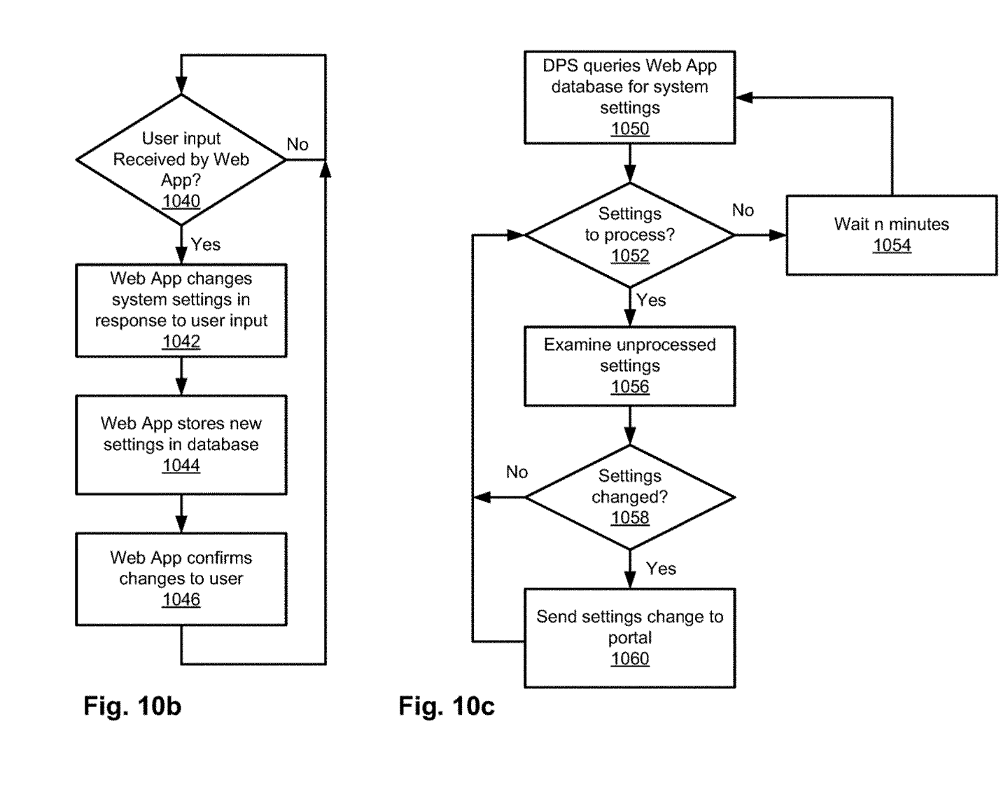

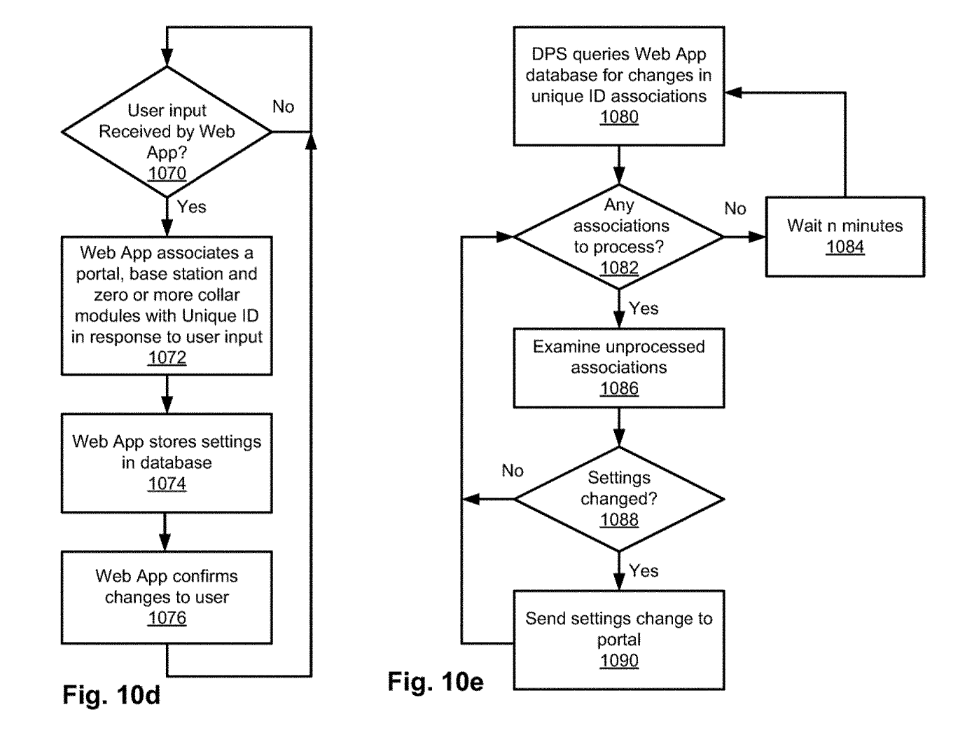

FIGS. 10a-10e are flow diagrams that illustrate the operation of the DPS and the Web application.

FIG. 10a illustrates processing of messages by the web application 130n upon receipt of messages from the DPS 120. A determination is made by the web application 130b whether a message bundle has been received by the web application 130b from the DPS 120 as illustrated in decision block 1010. If no message bundle has been received, the web application 130b awaits receipt of a message bundle that includes operational information, pet activity level and/or behavior information from one or more components of the animal control system 100. If a message bundle is received, it is stored in a database accessible by the web application 130b as depicted at block 1012 and the message bundle is unbundled into separate messages as illustrated in block 1014. A received message may contain operational information, pet activity level and/or behavior information depending on the source of the message.

The web application 130b processes each message of the message bundle in a loop until there are no more messages to process; i.e. the message count equals zero, as illustrated in decision block 1016. If the message count is greater than zero, such indicates that there are additional messages to unbundle and process.

If it is determined at decision block 1016 that there are messages to be processed, the web application 130b stores the next message in the database accessible by the web application 130b as depicted at block 1018. The web application 130b updates or creates records in the database as illustrated at block 1020 so that the database reflects the most recent operational information and/or pet activity level and behavior information from the various animal control system components.

The web application 130b also determines whether any of the information conveyed in the message being processed constitutes an alertable condition that warrants transmission of an alert or notification to one or more system users as illustrated at decision block 1022. If no alertable conditions are identified, control returns to decision block 1016 to determine whether any more messages of the message bundle remain to be processed.

If the web application 130b determines that information received represents an alertable condition, the web application 130b determines whether the system has been configured to forward SMS notifications of the alert condition involving specific operational information, pet activity level and/or behavior information as depicted at decision block 1026. If it is determined that no text alerts are to be sent in response to an alertable condition at decision block 1026, control passes to decision block 1030 for a determination whether an alert is to be sent to one or more individuals by email. If the web application 130b determines that an alert is to be sent as a text message, the contact information for each individual is retrieved from a contact information database and a text alert is transmitted over the computer network, e.g. the Internet, to each intended recipient as illustrated at block 1028 and control passes to decision block 1030.

The web application 130b determines whether an email notification or notifications of the alert condition is/are to be forwarded to one or more system users as depicted at block 1030. If the system has not been configured to forward any email notifications, control returns to decision block 1016 to determine whether there are any more messages of the message bundle to be processed. If the web application 130b determines that the system has been configured to transmit email notifications to one or more system users, the email address or each such user is retrieved from the contact database and the applicable notification is forwarded to the email addresses associated with the specified system users.

By way of example, and not limitation, an alertable condition may involve an open loop condition, a power outage, a determination that battery backup of a system component will cease to provide power within a specified time period, any circumstance that could relate to the safety or confinement of the pet or any other condition detectable by a component of the animal control system 100 that is configured as an alert condition.

FIG. 10b illustrates the operation of the web application 130b in response to system user input to change system settings, e.g. when a system user desires to modify the operation of the base station 102 and/or one or more collar modules 108. As illustrated at decision block 1040 the web application 130b determines whether it has received user input requesting a change of system settings. In response to the received input, the web application 130b modifies the system settings as depicted in block 1042 and stores the modified settings in a database as illustrated in block 1044. The web application 130b confirms to the system user via the browser 140a that the change has been recorded as depicted at block 1046. After confirmation of the recording of the change, control returns to decision block 1040 to await further user input.

FIG. 10c illustrates the operation of the DPS 120 with respect to handling of changes to system settings by a system user. From time to time, the DPS 120 queries the web application 130 database for system settings as illustrated in block 1050 and determines whether there are any modifications to the system settings that require further processing as depicted at decision block 1052. The DPS 120 examines the settings in the database as illustrated at step 1056 and determines whether any system settings, e.g. operational parameters for the base station 102 or collar module 108, have changed as illustrated at block 1058. If settings have changed, as illustrated at block 1060 the DPS prepares one or more commands to modify the settings in the device or devices for which settings have changed and forwards the command(s) to the communications portal 110 for delivery via RF links to the base station 102 and/or collar module(s) 108 as applicable to effect the changes to the animal control system 100 configuration. Control returns to decision block 1052 to await further changes to system settings that need to be processed by the DPS.

If it is determined by the DPS that no settings have been modified in the database that need to be processed by the DPS, the DPS delays for a predetermined period of time as illustrated at block 1054 and control returns to block 1050 at which point the DPS once again queries the database to determine if there have been changes for system settings.

FIGS. 10d and 10e illustrate the process by which unique IDs are associated with components of the animal control system 100 within the web application 130b. Referring to FIG. 10d, the web application 130b determines whether a system user has provided input pertaining to the association of unique IDs to components, e.g. the base station 102, communication portal 110 or collar module(s) 108, of the animal control system 100 as depicted at decision block 1070. If the web application 130b determines that a system user desires to associate a communications portal 110, a base station 102 or one or more collar module(s) with a unique ID or delete an existing association, the web application 130b makes the association or records the deletion as illustrated at block 1072. Deletion of an association may occur, for example, upon removal from the system of a failed component having a first unique ID, and replacement of that component with a new component having a second new unique ID. The web application 130b stores each unique ID in association with the respective component in a database or deletes the association, as applicable, and as illustrated at block 1074. The web application 130b confirms to the system user that the association of each unique ID with a specific component has been recorded in the database or has been deleted as depicted at block 1076. Control is then returned to decision block 1070 to await further requests for associations of new unique IDs with components within the system which may occur upon the replacement of a component (e.g. a failed or updated component) or the addition of a new component to the animal control (e.g. the addition of a collar module 108 associated with an additional pet).

If it is determined that there are no new unique ID associations to be added to the database or deletions of associations from the database to be made, control returns to block 1070 to await user input.

FIG. 10e illustrates the process by which changes in associations of unique IDs to components of the animal control system are conveyed by the DPS 120 to the communications portal 110. By conveying current unique ID associations to the communications portal 110, the portal 110 is able to perform message filtering so as to avoid forwarding of messages from the communications portal 110 to the DPS 120 that have unique IDs other than those in the animal control system of interest. More specifically, the DPS 120 queries the web application database for new/modified unique ID association information as depicted at block 1080. As illustrated at decision block 1082, the DPS 120 determines whether there are any changes to unique ID associations in the animal control system 100 that need to be processed. If there are any unprocessed associations they are examined as depicted at block 1086 and a determination is made whether changes to unique ID associations have been made as illustrated at block 1088. If changes have been made to any unique ID associations, the DPS 120 forward a message to the communication portal 110 in the form of a command to update the unique ID associations maintained by the communications portal 110. Thereafter, control returns to decision block 1082 to determine whether there are any further changes in unique ID associations to process. If it is determined at decision block 1088 that no changes need to be made with respect to unique ID associations maintained by the communications portal 110, control returns to decision block 1080.

If it is determined that there are no changes in associations to process at decision block 1082, the DPS 120 waits a predetermined period of time as depicted at block 1084 and the DPS 120 then once again queries the web application database to determine whether there have been any further modification to unique ID associations.

The web application 130b is further operative to receive input from a system user in which the system user is requesting reports or displays of information involving operational information of system components identified by respective unique IDS or activity level and/or behavior information pertaining to a pet associated with one or more collar modules 108. In response to such user requests, the web application 130b displays the requested information to the system user via the browser 140a.

The web application 130b further allows the system user to specify system users to which notifications and/or alerts should be transmitted in response to specified conditions and the email and/or text information associated with such system users that are to be used to forward desired notifications and/or alerts. The system users to receive such alerts or notifications, the alert conditions or notification conditions upon which such alerts or notifications are to be provided and the email and/or text information needed to forward the alerts and/or notifications are stored in a database by a system user through the web application 130b.

While the communications portal 110 is described as a component that is distinct from the base station 102, the functionality of the communications portal 110 may be integrated with the base station 102 and share a common housing. Moreover, when the communications portal 110 is integrated within the base station 102, components may be shared between the communications portal 110 and the base station 102. By way of example, a single RF transceiver may be used for communications between the communications portal 110 and the collar module(s) 108 since communications between the communications portal 110 and the base station 102 need not be via an RF link. Additionally, by way of example, power supplies and battery backup components of the base station 102 and the communications portal 110 may be provided as a singular power supply and a singular battery backup system. Additionally, processor functions may be shared by a single processor that performs the functions of the base station processor 210 and the portal processor 602 and a singular memory may serve as the base station memory 212 and the portal memory 110.

It should be understood by those of ordinary skill that the sequence of many of the steps in the above-described flow charts may be altered without altering the basic functions of the animal control system operation herein described. Moreover, modifications to and variations of the above-described systems and methods may be made without departing from the inventive concepts disclosed herein. Accordingly, the invention is not to be viewed as limited except by the scope and spirit of the appended claims.

1. Apparatus for use in an animal control system that includes a base station, a collar module configured to be worn by an animal, and a boundary wire that at least partially surrounds a pet control area, the base station comprising:
a first transmitter in the base station,
the first transmitter configured for coupling to the boundary wire and for transmission, via the boundary wire, of a first modulated RF signal having a first carrier frequency for receipt by the collar module, the collar module responsive to receipt of the first modulated RF signal and proximity of the collar module to the boundary wire to generate a stimulus to the animal;
a second transmitter in the base station configured to transmit a second modulated RF signal having a second carrier frequency greater than the first carrier frequency; and
base station circuitry in the base station, wherein the base station circuitry includes monitoring circuitry configured to monitor information indicative of a configuration of at least one of the first transmitter, the second transmitter and the base station circuitry or information indicative of an abnormal condition associated with the base station circuitry;
wherein the second transmitter is configured to transmit the second modulated RF signal for receipt by a remote computerized device, the second modulated RF signal including information indicative of the configuration of at least one of the first transmitter, the second transmitter and the base station circuitry, or information indicative of the abnormal condition associated with the base station circuitry.

2. The apparatus of claim 1 wherein the first carrier frequency is between 1 khz and 20 khz and the second carrier frequency is between 800 megahertz and 1 gigahertz.

3. The apparatus of claim 1 wherein the first carrier frequency is between 1 khz and 20 khz and the second carrier frequency is approximately 2.4 gigahertz.

4. The apparatus of claim 1 wherein the first carrier frequency is between 1 khz and 20 khz and the second carrier frequency is between 10 khz and 6 gigahertz.

5. The apparatus of claim 1 wherein the second transmitter data includes an apparatus identifier that is unique and different from all other apparatus identifiers associated with other apparatus in the animal control system.

6. The apparatus of claim 1 wherein the information comprises:
an indication of the first carrier frequency;
an indication of a range selection;
an indication of a rate selection;
an indication of a mode selection;
an indication of an open loop or defective condition associated with the boundary wire;
an indication related to status of a power supply within the base station; or
an indication related to status of a battery backup system associated with the base station.

7. The apparatus of claim 1 wherein the second transmitter is configured to transmit the second modulated RF signal periodically.

8. The apparatus of claim 1 wherein the second transmitter is configured to transmit the second modulated RF signal in response to a query.

9-40. (canceled)

41. The apparatus of claim 1 wherein the apparatus further includes the remote computerized device.

42. The apparatus of claim 1 wherein the remote computerized devices comprises one of a desktop computer, a workstation, a laptop computer, a tablet and a computerized mobile device.

43. The apparatus of claim 41 wherein the apparatus further includes a communications portal, wherein the second transmitter is configured to transmit the second modulated RF signal to the remote computerized device via the communications portal.

44. The apparatus of claim 43 wherein the apparatus includes the remote computerized device and another computerized device, the apparatus further including a web server executing a web application, wherein the web application is responsive to information contained in the second modulated RF signal to transmit a first notification signal to the remote computerized device and a second notification signal to the other remote computerized device.

45. The apparatus of claim 41 wherein the second transmitter is configured to transmit the second modulated RF signal to the remote computerized device via a communications network that includes at least one wireless communications link.

46. The apparatus of claim 1 wherein the apparatus further includes a collar module configured to be worn by the animal, the collar module including a collar module transmitter and collar module monitoring circuitry configured to monitor information indicative of a configuration of the collar module, the collar module transmitter configured to transmit for receipt by the remote computerized device a collar module RF signal that includes the information indicative of the configuration of the collar module.
